(19) United States
(12) Patent Application Publication
(10) Pub. No.: US 2012/0179571 A1
(43) Pub. Date: Jul. 12, 2012

(54) SYSTEM AND METHOD FOR PRODUCING DIGITAL IMAGE PHOTO-SPECIALTY PRODUCTS

(75) Inventor: John J. Grosso, III, Charlotte, NC (US)

(73) Assignee: Portrait Innovations, Inc., Charlotte, NC (US)

(21) Appl. No.: 13/347,271

(22) Filed: Jan. 10, 2012

Related U.S. Application Data
(60) Provisional application No. 61/431,643, filed on Jan. 11, 2011.

(51) Int. Cl. G06Q 30/06

(52) U.S. Cl. 705/26.5

(57) ABSTRACT

A web-based computer system and method for making a photo-specialty product is set forth herein. The system comprises a computer-based device residing at a first location having a computer software application for producing a photo product component from a digital image, and a computer software template residing at a second location for receiving the photo product component transferred from the first location to produce at least one purchase or print ready photo-specialty product.

### CROSS-REFERENCE TO RELATED APPLICATIONS

This application claims the benefit of U.S. provisional application No. 61/431,643, filed Jan. 11, 2011, herein incorporated by reference in its entirety.

### FIELD OF THE INVENTION

The present invention relates to digital imaging technology, more particularly to a system and method for producing digital image photo-specialty products.

### BACKGROUND OF THE INVENTION

Digital imaging photography has become increasingly popular and is rapidly overtaking use of traditional film by not only casual photographers but also professional photographers and professional photography studios. As a result, there is an increasing ability to create digital image portraits and an increasing consumer demand not only for digital image portraits but also other photo-specialty products such as photo-books or albums and calendars. These photo-specialty products (photo-books, photo-cards, photo-calendars and the like) represent one of the fastest growing parts of the photography industry.

A number of websites exist on the Internet which provide an individual who has taken his or her own digital photos the option of uploading them to a website. At the website, the individual must have the capabilities (for example, Internet connectivity with sufficient bandwidth) to figure out how to upload the digital images and how to manipulate the digital images to develop his or her own photo products. This is often a very time consuming and technically complicated process. As a result, a limited number of individuals are able to make such products. Furthermore, such resulting products are often not of a professional or printable or saleable or purchasable quality as the individual does not have the training or equipment of a professional to take the digital images or to manipulate the digital images to achieve a professional quality photo-specialty product. Furthermore, this can be a very time consuming and frustrating experience for the user.

Accordingly, there is a need for a system and method to produce professional quality digital image photo-specialty products in an easy, less time consuming, and automated manner.

### SUMMARY OF THE INVENTION

The present invention relates to a web-based computer system comprised of one or more system components communicatively connected to one another in a computer network. The system generally comprises at least one computer or computer-based device residing at a first location such as a physical location like a portrait studio, retail store, or with a professional photographer having a computer software application suitable for making professional quality photo-specialty product components, a photo product component-ready template for making photo-specialty products wherein the template resides at a second location such as in a digital image cloud or on a server, a database for storing data such as digital images and text, and a computer or computer-based device for providing a customer access over the Internet or Intranet to a website at the second location such as in the digital image cloud or on the server.

The computer-based system and method of the present invention provides for automatically creating customized digital image photo-specialty products using digital images which may be from an in-studio photographic session or a professional photographic session, the photo-specialty products being accessible on a website over the Internet or Intranet.

In an embodiment of the present invention, a customer visits a physical location such as a portrait studio, retail store or location, or professional photographer and has digital images taken in the studio, retail store, or by the photographer. The physical location such as the portrait studio has a computer system that allows for the preparation and/or customization of the digital images in a final, “template-ready” format which then automatically uploads those template-ready digital files to the web server and populates one or multiple photo-specialty product template(s). The combination of prepared digital image and template produces purchase and print ready photo-specialty products and makes them available online. A password is issued to the customer to permit the customer to go to the website to view, share, customize, add-to, order and print the photo-specialty products. A customer has a predetermined number of days to go to the website, where a customer can change or customize the photo-specialty products such as photo-books, photo-calendars, photo-cards, custom stationery, among others. If a customer does not log in to the website within a predetermined amount of time such as three days, certain of the photo-specialty product(s) created by the merging of the product components made in-studio with the product templates residing online may ship to the customer automatically. The website also allows for the viewing, sharing, editing, printing and so forth of the individual digital images used in the photo-specialty components and products as well. The physical location such as the portrait studio uses the photo-specialty products to drive traffic to the location, possibly gives away the photo-specialty products as premiums, as well as offers other products for sale online.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

FIG. 1 is a schematic diagram illustrating the web-based computer network in which the system and method of the present invention operates.

FIG. 2 is a schematic diagram illustrating a process flow from PPCM to component-ready template to photo product to website.

FIG. 3 is a schematic diagram illustrating a process flow from PPCM to component-ready template to photo product.

FIG. 4 is a schematic diagram illustrating a proposed PPCM computer screen shot.

FIG. 5 is a schematic diagram illustrating a proposed photo product component-ready template with and without PPCM input.

FIG. 6 illustrates a proposed website screenshot with final photo products on display.

### DETAILED DESCRIPTION OF THE INVENTION

The following detailed description of the embodiment(s) is merely exemplary in nature and is in no way intended to limit the invention, its application, or uses.

The web-based computer system the present invention generally comprises: (a) at least one computer or computer-based device residing at a first location wherein the computer or computer-based device comprises computer software and (b) a photo product component-ready template for making photo-specialty products wherein the template resides at a second location and is compatible to receive the components of the first location. For example, the first location may be a physical location such as at a portrait studio, retail location, or professional photographer sitting. However, it is also within the scope of the present invention that the first location is a virtual location such as a computer hard drive or other computer-based device of a person or entity, the device having the capability to download a computer software application suitable for making professional quality photo-specialty product components. The system of the present invention also comprises a photo product component-ready template for making photo-specialty products wherein the template resides at a second location or could reside at both the first and second locations and is compatible to receive the components of the first location. The second location may be either a physical location or a virtual location.

Thus, the system and method of the present invention provides for separation of the digital image (in a computer software application for making the photo product template-ready components) from the component-ready template itself in an automated process that produces a consumer-acceptable, professional, purchase/print ready final photo-specialty product. This is believed to be a unique feature of the present invention in contrast to existing systems and methods having both the “digital image” plus “template” together either at only the physical location (in the case of a downloadable application) or only online (in the case of the websites that offer these products and/or services).

However, illustrated below is a non-limiting embodiment of the present invention in which the first location is a physical location such as at a portrait studio, retail location or professional photographer sitting and the second location is in a digital cloud or on a server.

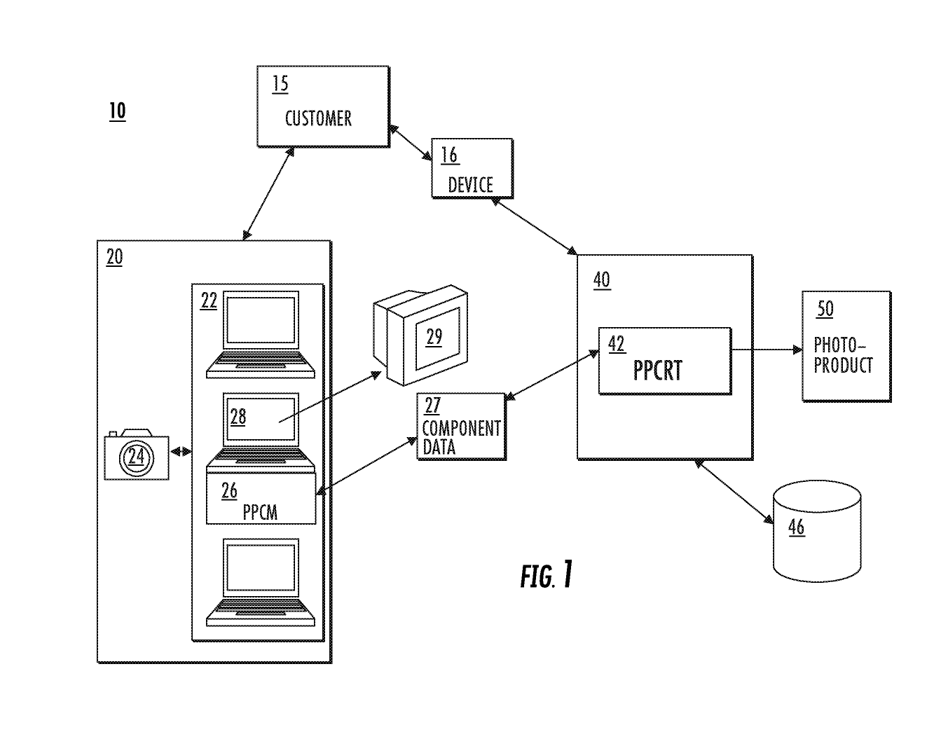

Referring to the figures, FIG. 1 is a schematic diagram illustrating a web-based computer network 10 in which the system and method of the present invention operates. As shown in FIG. 1, the web-based computer network 10 includes a local area network (LAN) (not shown) that is operated in a digital portrait studio system 20 or the like. The LAN operatively connects a plurality of computers 22. At least one of the studio computers 22 includes studio relational databases, such as customer appointments, customer resource management information, photography and sales, studio administration, print production, and Internet/Intranet information. Such information can be displayed on a display screen 28 of one or more of the computers 22 or on a separate or independent display screen 29. The LAN is operatively connected to the Internet and/or an Intranet system through an output device (not shown), such as a modem or the like.

The digital portrait studio system 20 also includes at least one digital recording device 24. In one embodiment, the digital recording device 24 is a digital still-frame camera, such as a Fujifilm® FinePix S2 Pro Digital Camera™ or Kodak® Professional DSC 760 Digital Camera™ that feature a Nikon® F5 body. Other digital cameras could be used instead that provide similar performance. Digital images are captured and stored (could be on a reusable memory or “PC” card as opposed to standard professional film or could be direct to a computer's hard drive or a server by tethered method or wireless like Bluetooth). The camera 24 can also be hard wired or tethered to one of the computers 22. Because the camera 24 is digital, the cost per exposure is negligible, and therefore the photographer is able to take an unlimited number of digital images during a photo session without encountering substantial cost. Because the cost of storing the digital content is so inexpensive an essentially unlimited number of images may be stored.

The digital portrait studio system 20 of the present invention includes digital processing equipment, including processing software and dedicated computers, whereby each digital image can be transformed into a plurality of variations using user-friendly menus and tools. For example, the processing software includes code that provides for modifying each digital image, including digitally “retouching” portions of the image, cropping and centering, combining the image with other images in a combination image, changing the size of the image and final print, adding graphics or text, changing the tone or finish of the image, changing the background, creating a collage, creating vignettes of various colors, and so on. Advantageously the processing software allows for all these finishes and customizations without the need of outside software or applications. A display, such as the computer monitor display 28 or the display screen 29, displays the digital images before and after any changes are made by the customer, and the final images are saved by at least one of the studio computers 22 in the LAN. Thus, the customer is able to take an image and create an entirely different image with an entirely different look and feel from the original image. Multiple unique and customized images can also be created from a single original image, which provides value and convenience for the customer.

In addition to the above functionality, at least one of the physical location (such as portrait studio or retail store) computers 22 in the system 20 comprises a computer software application referred to herein as the Photo-Product-Component-Maker (PPCM). The computer software application 26 comprises computer code or computer executable instructions for making professional, template-ready photo-specialty product components. The PPCM 26 is suitable for image content, for metadata content such as text, or for a combination of image and metadata content.

The PPCM 26 provides the ability to quickly, simply and properly arrange an image and/or metadata into a template-ready photo-specialty product component. The PPCM is pre-configured to produce template-ready photo-specialty product components or outputs 27 from the physical location's digital images that are compatible with and match the specifications of one or more photo-specialty component-ready product template(s) 42 that reside on a server 40. The combination of PPCM(s) and PPCM-ready template(s) produces a variety of purchase/print-ready, photo-specialty products such as photo-books, photo-cards, custom stationery, photo-calendars and the like which are accessible by a customer 15 via the Internet at a website associated with the physical location such as a portrait photography studio, retail store, or professional photographer.

The specifications and functions of the PPCM computer software application include, but are not limited to, editing, enhancing and adjusting images based upon size, aspect ratio, scaling/resolution, compression, encryption, file type, rotation, orientation, zoom, crop, position, tone, color, depth, contrast, hue, brightness, layering, perspective, slicing, distorting, white balance, sharpness, application of special effects, inpainting, noise reduction, compositing/splicing, and skewing as well as adding text and other associated and related data and metadata. The metadata included in the PPCM computer software application designates, for example, which photo-specialty product templates to automatically populate using the PPCM(s), in what order, etc. For example, it may designate to automatically populate a 8×8 photo album, a 12×12 photo album, and a calendar with template-ready digital images.

There are many possible methods by which the photo product component maker (PPCM) software application is used to prepare the digital images to populate the photo-specialty product template in accordance with the present invention. One such method of using the PPCM software comprises configuring a digital image captured by the digital image recording device to meet predetermined specifications (such as a specified image size or aspect ratio) that match the specifications of the photo product component-ready template. The digital image, for example, is configured by cropping, zooming, or otherwise manipulating the digital image to a specified aspect ratio or image size. The aspect ratio or image size is then held fixed or constant regardless of any editing or other manipulation performed on the digital images in the system 20. For example, an aspect ratio of 1:3 or an image size of 10×13 may be selected as preferred depending upon what is desired for a given template. Although an example of a fixed or preferred aspect ratio has been described herein, it is also possible to have different aspect ratios, sizes, or other criteria associated with or applied to the images. It is desirable to save the images in this configured format for mapping purposes. One or more of the configured images are selected to be applied to or used in a photo product. After selection of the images by the customer or other user, the images populate the template and are mapped to the photo product(s). It is desirable to map the images to the product that requires the most photos such as a twenty image photo book or twelve image photo calendar.

The method for populating the photo-specialty template optionally comprises tagging individual digital images with one or more key words that are associated with one or more component-ready templates. In the case of a photo product for a holiday such as a Mother's Day photo book, for example, the digital images are cropped or manipulated to achieve a fixed or specified aspect ratio. The cropped images are selected and tagged with a keyword, phrase, or other image identifier such as “Mother's Day”. The tag becomes part of the metadata and data file associated with the image(s). As part of the auto-population or mapping process, the template 42 uses this information about the image to map the image into one or more specific locations in the template such as the month of May on a calendar or on a specific page in a photo book or on the side of a coffee mug, with each product utilizing the same fixed or preferred aspect ratio as the image. Other tags may be applied to other images such as “Valentine's Day”, “Father's Day”, “Right Profile”, “Left Profile”, “Black & White” among others for mapping to other photo products.

Once the arrangement of image and/or metadata is completed in the physical location using the PPCM then an Extensible Markup Language (XML)-type package is created with the PPCM(s) output including both image content and metadata. Using the PPCM(s), one or more photo product components 27 are saved in a data file and encoded for data transfer such as in a XML-based file format by the computer software application. The photo product components 27 in a data file are transferred over the Intranet or Internet to a server 40 or to a digital image cloud/server (not shown) comprised of networked computer hardware and software (and digital images) to automatically populate a photo-specialty product component-ready template(s) 42 residing on a server or in the digital image cloud. On the server 40 or in the digital image cloud resides the photo-specialty product component-ready computer software-based template 42. The photo-specialty product component-ready template 42 is used to produce one or more photo-specialty products 50 including, but not limited to, photo-cards, photo-calendars, photo-books, custom stationery and mugs. A database 46 in communication with the server 40 stores data such as digital images and text.

As indicated, the photo product component-ready template resides at a web-accessible location outside of the PPCM' s originating location. The photo product component-ready template is pre-defined and pre-constructed, “waiting”, to automatically receive and accept input sent from the PPCM(s). Once the photo product component-ready template receives PPCM input, it creates designated photo products such as photo-cards, photo-calendars, and photo-books in a professional quality, purchase or print ready format. Multiple templates can receive input from a single PPCM or a set of PPCMs to create purchase or print ready photo products. For example, a single PPCM can populate a template for a card, 8×11 calendar, 8×8 photo book and 12×16 photo book automatically and purchase and/or print without any human interaction. The products which are populated with the PPCM input are determined by metadata programmed or included in the PPCM or by pre-configuring the templates on the web. The photo components produced or generated by the PPCM are configured or set to meet predetermined specifications (such as a set image size or aspect ratio) that match the specifications of the photo product component-ready template in order to automate the process for making a photo-specialty product. This feature of the system and method of the present invention eliminates the disadvantages associated with many existing consumer web-based photo sites and applications in which manual intervention is required on behalf of the consumer to manually transfer, upload, and format the digital images to a website or in an application in order to make a photo-specialty product.

The PPCM computer software application itself is accessible at the originating the location of the digital images After the photo product component-ready template 42 is automatically populated with the template-ready photo product components to make the final print/purchase-ready photo-specialty product(s) 50, the photo-specialty product(s) is accessible and viewable online where it may be shared, customized and from where photo-specialty product(s) 50 may be ordered and/or printed. The photo-specialty product is accessible by the customer 15 using a computer or other computer-based device 16 having web access such as a personal data assistant, tablet, or phone. Once the PPCM input is merged with the template to produce the photo-specialty product(s) 50, the customer can then, if he or she so chooses, customize the final product template or the template inputs and images.

As indicated above, the output of the merging of PPCM with photo product component-ready template (i.e. a photo product(s))—the photo product is accessible and available for a customer 15 or other user to view, share, order, or customize further via the website. In one such embodiment, the customer 15 accesses the website by logging into a user account such as with a username and password using a computer or other computer-based device having web access.

Payment for a photo-specialty product 50 is made either at the originating location such as at the studio, retail, or professional photographer location or via the website. Alternatively, a professional studio or photographer may use a photo product as a promotional item or giveaway, for example, to encourage greater in-studio spending or as an incentive to draw customers to the studio or to a professional sitting.

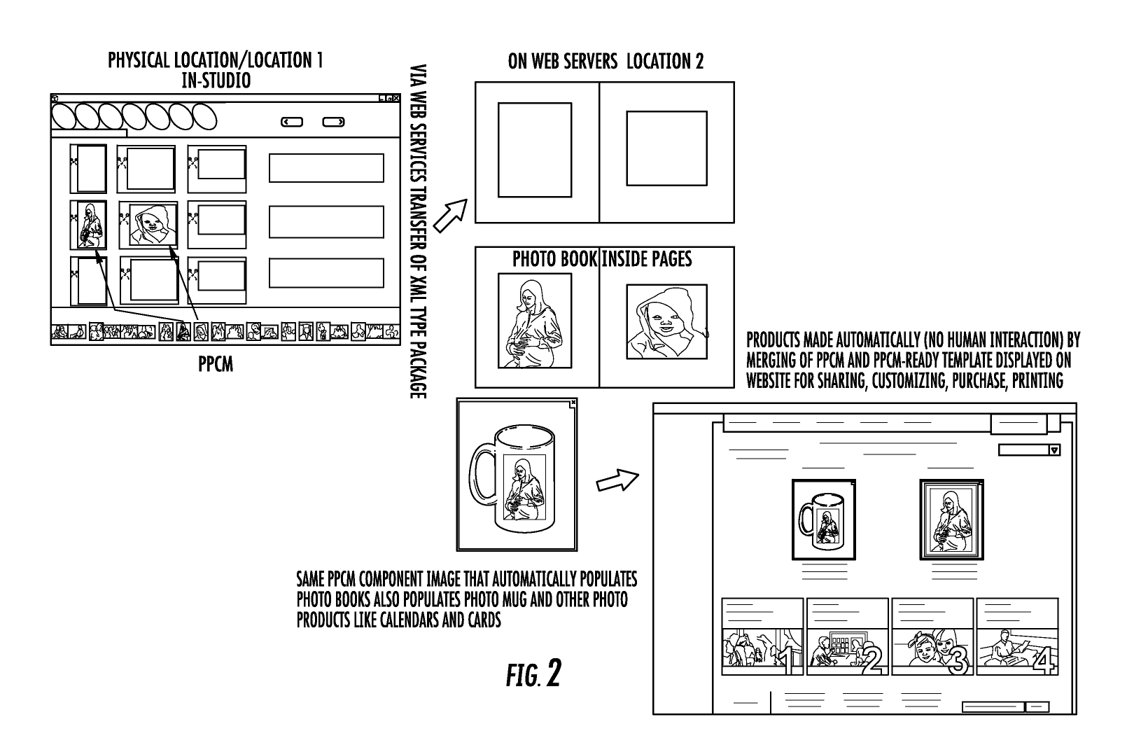

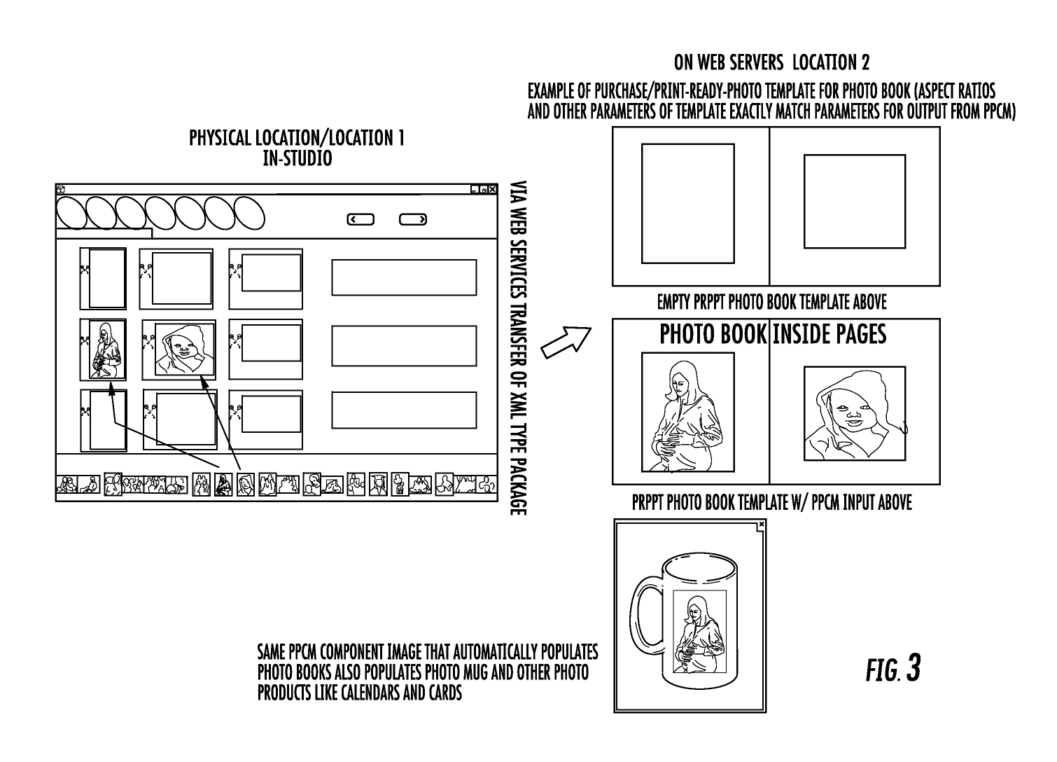

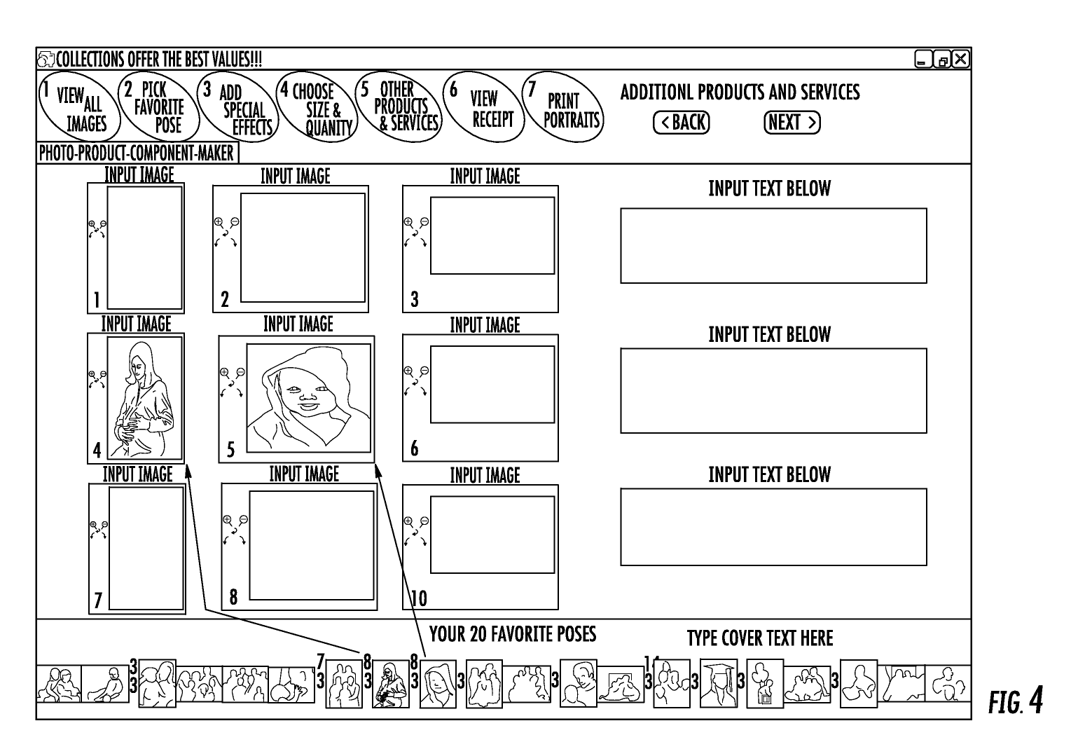

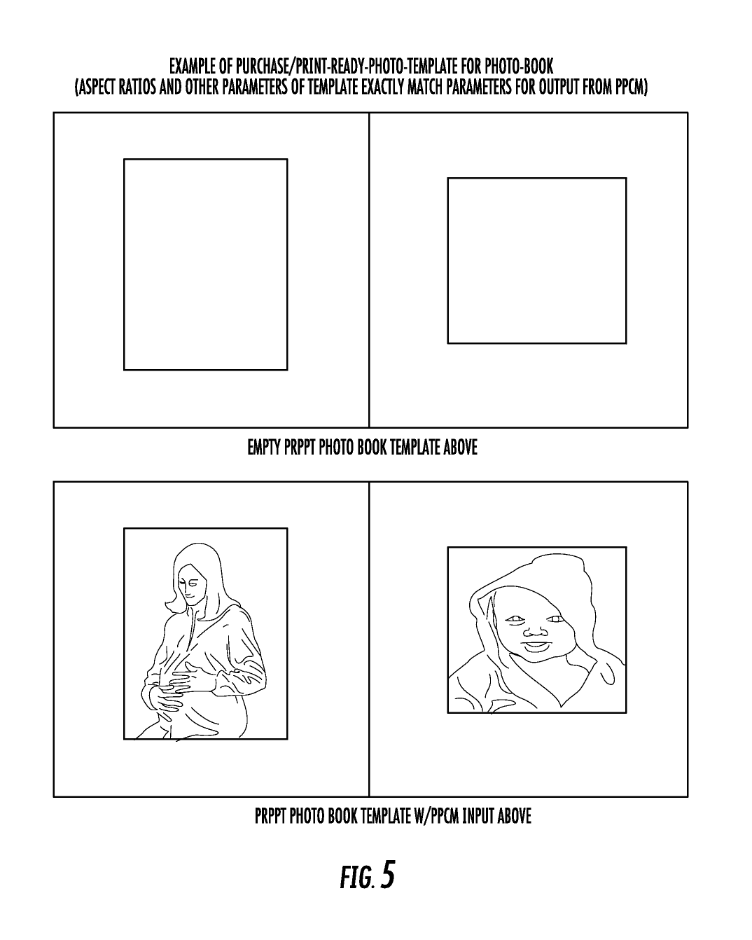

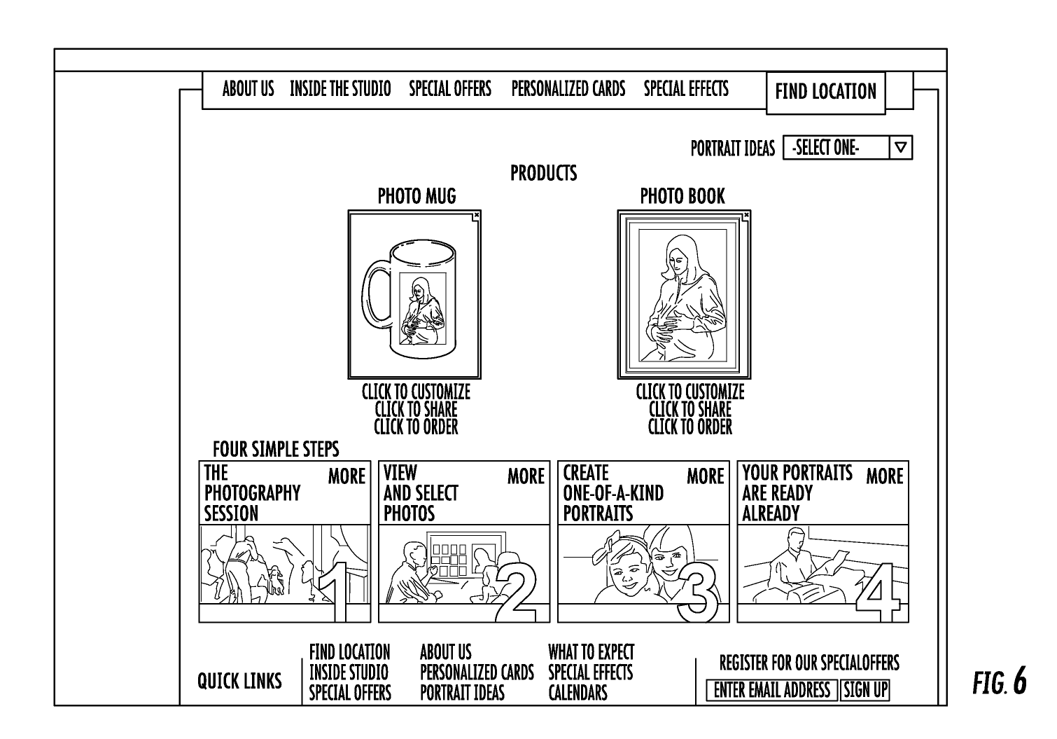

FIG. 2 is a schematic diagram illustrating a process flow from PPCM to component-ready template to photo product to website. As set forth in FIG. 2, the same PPCM component that automatically populates photo-books, for example, also populates other photo products such as a mug, calendar and card. The photo products are thus made automatically without human interaction by merging of the PPCM and PPCM-ready template and are displayed on a website for sharing, customizing, purchase and printing. FIG. 3 is a schematic diagram illustrating a process flow from PPCM to component-ready template to photo product. FIG. 4 is a schematic diagram illustrating a proposed PPCM computer screen shot. FIG. 5 is a schematic diagram illustrating a proposed photo product component-ready template with and without PPCM input. As set forth in the example of FIG. 5, aspect ratios and other parameters of the template exactly match parameters for output from the PPCM. FIG. 6 illustrates a proposed website screenshot with final photo products on display.

In one aspect of the present invention, a customer may customize the photo products. In another aspect of the present invention, it is an optional feature of the present invention to provide a customer with the capability to upload his or her own personal photos for use in conjunction with a photo product such as to further customize a photo product. In still yet another aspect of the present invention, a photo product may automatically be printed and shipped to a customer even, for example, if a customer did not make any customizations to a photo product or even if the customer did not even access or view the photo product via the web but perhaps merely purchased portraits in the studio.

Another embodiment of the present invention comprises populating a digital image cloud with professionally taken, premium images of a customer and then through that digital image cloud populating and displaying to the customer for purchase on a website or for additional customization of a variety of photo products such as custom stationery products including, but not limited to, photo books and calendars or other items such as mugs or key chains.

An advantage of the system and method of the present invention is that a physical location such as a portrait studio, retail store, or professional photographer may be the initial content creator and may have in-person interaction with the customer using the in-location computer software. For example, it is possible that during the in-studio session using the PPCM computer software, the studio prepares and finalizes the image contents for the photo-products, not knowing necessarily which if any products will be made, viewed, ordered or printed, then uploads the digital images and product ready component images of the customer from the session which allows the servers/cloud to merge the components with ready templates and then display an auto-loaded photo book(s) or product(s) for viewing, sharing, purchasing, printing, or a combination thereof. Therefore, in accordance with the present invention, it is possible to create a variety of purchase and print-ready photo-specialty products automatically without having the digital images and templates in the same location and without a human even necessarily knowing which product templates and final photo-specialty products the digital images may be used to populate, display and print. The customer is given the option to log-in to an online account and customize the print-ready photo products further if desired. Alternatively, after a predetermined period of time such as two days for example, if the customer has not “touched” the output final photo product(s) it will auto-order one or more of them to be shipped to the customer. The studio may also simply auto-order the photo-specialty product without the customer having the ability to view or customize online but the PPCM to PPCM-ready template combination process would be the same.

Another embodiment of the present invention relates to an automated method for creating and leveraging an online digital image cloud unique to a creator of premium, professional digital content like a portrait studio or professional photographer. According to the method of the present invention, professional digital images are automatically sent over the web to a pre-configured account in a digital image cloud. This is done in association with an in-studio visit that includes professional and customer collaboration on creation, selection, purchase and printing of digital images. According to the method, (a) images are sent to the cloud as a defined group or “session”, (b) images are associated with a specific studio/site visit by date/time/purchase amount/photographer, etc., (c) images are associated with the customer and the preferences of the customer (likes and dislikes, purchase and no-purchase), (d) images are sent to a pre-configured online customer account, and (e) images in the cloud automatically populate a variety of photo products such as stationery, photo-books, photo-cards, photo-calendars, photo-mugs, etc.

With regard to step (d), a customer may have an existing online account or a studio may create a new online account for the customer. The customer may access the account by logging in from a website or by other means like clicking on a link that is sent to the customer's email inbox post-visit. With regard to step (e), when a customer logs into an online account, the customer sees digital images pre-populated into a cloud or digital images pre-populated into photo products. A customer can with one click order any variety of pre-populated products. A customer can customize any variety of pre-populated products and then order. A customer can create variety of new products and then order. A customer can share images in the cloud or photo product.

Among the advantages of the system and method of the present invention is that only a creator of professional, digital content can access the photo product component maker software application. As a creator of professional, digital content, the content creator is able to assist his customer in omitting certain time consuming, confusing, bandwidth intensive steps (such as sorting images, uploading images, populating certain multi-media products with images) that are necessary with consumer only photo-specialty/custom stationery site or application experiences. Instead, with the system and method of the present invention, the customer gets directly to a professional quality photo product without the aforesaid disadvantages.

However, for a more advanced customer, the system and method of the present invention provides still yet another embodiment of the present invention, namely a method of populating the digital image cloud by the customer. The computer-based system of the present invention provides a customer-focused computer software application to facilitate the uploading of digital images to the cloud. The customer-focused computer software application provides for the convergence of professional or non-professional digital images that already exist in the cloud with personal images that exist or are transferred to the cloud by the customer using a web accessible computer or kiosk or other device. The computer software application is downloaded from the Internet and saved to a computer or a media storage device such as CD from the studio. The computer software application comprises computer code or executable instructions for scanning the computer or media storage device to find all digital images in a certain file format such as a jpeg or bmp. The computer software application comprises code or instructions for compiling digital images into a group or a file. The computer software application comprises code or instructions for de-duplication of images. The computer software application comprises code or instructions for resolution configuration or selection of images. The computer software application comprises code or instructions for removing images from the group such as those images that a customer may not want to include in the cloud. The computer software application comprises code or instructions for sorting and/or labeling of images. The computer software application comprises code or instructions for one-click uploading of images into the digital image cloud or onto a server into the account of the user. This is useful because it automates what can be a time consuming, confusing process for consumers and which is often a barrier to adding content to the cloud.

In addition to providing systems and methods, the present invention also provides computer program products for carrying out the steps and features described herein. The computer program products have a computer readable storage medium having a computer readable program code means embodied in the medium. The computer readable storage medium may be part of a memory device, such as the computer 22, any may implement the computer readable program code means to carry out the steps and features of the various embodiments as described herein.

A detailed description of a digital image portrait studio system and method for producing portraits suitable for use in accordance with the present invention is found in U.S. Pat. No. 7,193,742, U.S. Pat. No. 7,580,148, U.S. Patent Publication No. 2008/0218600, and U.S. Patent Publication No. 2009/027/0273809 each of which are incorporated herein by reference in their entireties.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A web-based computer system for making a photo-specialty product, the system comprising:
a computer-based device residing at a first location having a computer software application for producing a photo product component from a digital image, and
a computer software template residing at a second location for receiving the photo product component transferred from the first location to produce at least one purchase or print ready photo-specialty product.

2. The system according to claim 1, wherein the first location is a physical location.

3. The system according to claim 2, wherein the physical location is selected from the group consisting of a portrait studio, a retail location, and a professional photographer sitting.

4. The system according to claim 1, wherein the photo product component is in a template-ready format when transferred from the first location.

5. The system according to claim 1, wherein the photo product component comprises metadata corresponding to the digital image and the template.

6. The system according to claim 1, wherein a user account is associated with the photo-specialty product.

7. The system according to claim 6, wherein the user account provides access to viewing, sharing, customizing, ordering, printing, or a combination thereof.

8. The system according to claim 1, wherein the photo-specialty product is a photo-book, photo-calendar, photo-card, stationery, key chain, or mug.

9. The system according to claim 1, wherein the photo-specialty product is of professional quality.

10. The system according to claim 1, wherein the second location is a computer connected to an internet, an intranet, or a digital image cloud.

11. The system according to claim 1, wherein the computer-based device comprises at least one relational database.

12. The system according to claim 11, wherein the at least one relational database comprises data selected from the group consisting of customer information, appointment information, management information, photographic information, sales information, administrative information, production information, and a combination thereof.

13. The system according to claim 1, wherein the computer-based device is a part of a local area computer network.

14. The system according to claim 1, wherein the system further comprises at least one digital recording device operatively connected to the computer-based device for capturing the digital image.

15. The system according to claim 1, wherein the software application has functionality for modifying the digital image.

16. The system according to claim 15, wherein modifying comprises digitally retouching the image, cropping the image, centering the image, combining the image with other images, changing the size of the image, modifying the aspect ratio of the image, adding graphics to the image, adding text to the image, adding metadata to the image, changing the tone of the image, changing the finish of the image, changing the background of the image, creating a collage with the image, creating a vignette for the image, or a combination thereof.

17. The system according to claim 1, wherein the computer-related device at the first location is capable of sending an XML-type package having image content, metadata, or a combination thereof.

18. The system according to claim 1, wherein the template resides on a server or digital image cloud.

19. The system according to claim 1, further comprising a database for storing data transferred from the first location.

20. The system according to claim 1, wherein the template is populated with metadata associated with the photo product component.

21. The system according to claim 1, wherein the photo product component has a fixed aspect ratio.

22. The system according to claim 1, wherein the photo product component has a fixed image size.

23. The system according to claim 1, wherein the at least one photo-specialty product is accessible over the internet.

24. The system according to claim 1, wherein the at least one photo-specialty product is viewable over the internet.

25. The system according to claim 1, wherein the photo-specialty product is capable of being customized or modified by a user.

26. The system according to claim 25, wherein the user is a professional photographer.

27. A method for making a photo-specialty product in a web-based computer system, the method comprising:
producing a photo product component from a digital image using a computer software application, the computer software application residing on a computer-based device at a first location, and
transferring the photo product component to a photo product component-ready computer software template, the computer software template residing at a second location.

28. The method according to claim 27, wherein the computer software template resides at the first location in addition to the second location.

29. The method according to claim 27, wherein the first location is a physical location.

30. The method according to claim 27, wherein the physical location is selected from the group consisting of a portrait studio, a retail location, or a professional photographer sitting.

31. The method according to claim 27, further comprising populating the template with the transferred photo product component.

32. The method according to claim 31, wherein the template comprises metadata associated with the photo product component.

33. The method according to claim 27, further comprising producing at least one purchase or print ready photo-specialty product.

34. The method according to claim 27, further comprising associating a user-specific account with the photo-specialty product.

35. The method according to claim 27, wherein the photo-specialty product is a photo-book, photo-calendar, photo-card, stationery, a key chain, or a mug.

36. The method according to claim 27, further comprising automatically shipping at least one photo-specialty product after a predetermined amount of time.

37. The method according to claim 27, wherein producing the photo-specialty product is performed at the first location.

38. The method according to claim 27, further comprising utilizing information from at least one relational database to produce the photo product component.

39. The method according to claim 27, further comprising capturing the digital image using a digital recording device prior to producing the photo product component.

40. The method according to claim 39, wherein the digital recording device is connected to the computer-based device at the first location.

41. The method according to claim 27, wherein transferring comprises sending an XML-type package to the second location.

42. The method according to claim 27, wherein the XML-type package comprises image content, metadata, or a combination thereof.

43. The method according to claim 27, further comprising storing data from the photo product component in a database associated with the second location.

44. The method according to claim 27, further comprising populating the template based upon metadata associated with the photo product component.

45. The method according to claim 27, further comprising making available for purchase at least one photo-specialty product created from the template through a user account.

46. The method according to claim 27, further comprising configuring the digital image prior to populating the template.

47. The method according to claim 46, further comprising configuring the digital image prior to populating the template by cropping.

48. The method according to claim 46, wherein the configured digital image has a fixed aspect ratio or fixed image size.

49. The method according to claim 27, further comprising automatically shipping the photo-specialty product automatically after a predetermined amount of time.
